(19) United States
(12) Patent Application Publication
(10) Pub. No.: US 2014/0172569 A1
(43) Pub. Date: Jun. 19, 2014

(54) Method for Implementing a Customizable Interactive Menu System with User Interaction Data Analysis Capability by Executing Computer-Executable Instructions Stored On a Non-Transitory Computer-Readable Medium

(71) Applicant: International Advertising Solutions, El Paso, TX (US)

(72) Inventors: Juan M. BANDA, Bozeman, MT (US); Rene Eduardo RASCON, El Paso, TX (US); Rafael Mario CHAVEZ, Chihuahua (MX)

(73) Assignee: International Advertising Solutions, El Paso, TX (US)

(21) Appl. No.: 14/108,171

(22) Filed: Dec. 16, 2013

Related U.S. Application Data
(60) Provisional application No. 61/737,448, filed on Dec. 14, 2012.

(51) Int. Cl. G06Q 50/12; G06F 3/0482

(52) U.S. Cl. CPC G06Q 50/12; G06F 3/0482
USPC 705/14.55; 705/15

(57) ABSTRACT

A method for implementing a customizable interactive menu system with user interaction data analysis capability by executing computer-executable instructions stored on a non-transitory computer-readable medium is a digital replacement for paper restaurant menus with a customizable menu layout. The menu layout mimics traditional paper menus, displaying a plurality of menu pages on a personal computing device, including a menu start page, at least one menu items page, at least one advertisement page, and a menu end page. Users may select items on a menu items page or an advertisement page, and all user interactions are recorded and later analyzed with data mining and pattern recognition algorithms to produce sorted interaction data and layout suggestions, which the restaurant owner or manager may use to customize and optimize the menu layout.

The current application claims a priority to the U.S. Provisional Patent application Ser. No. 61/737,448 filed on Dec. 14, 2012.

### FIELD OF THE INVENTION

This invention relates generally to the field of interactive menu systems in the food services area. More specifically, the invention comprises the use of interactive technology as well as data analysis algorithms to create interactive customizable menus based on data analysis and user provided parameters.

### BACKGROUND OF THE INVENTION

There are many known interactive menus in the food services industry. Most of these menus provide a multimedia experience to the listener by displaying their contents in an interactive fashion. While all these interactive menus provide a multimedia experience to the user, they fail to add any other value other than being aesthetically pleasing. With the current popularity of gathering of massive amount of data in many consumer related domains, there is a critical need to be able to provide the restaurant with reports of what the consumers are actually looking at, and for how long, in order to help them customize their menus, remove unpopular items, or feature popular items by time of the day, season of the year, and even age ranges. This level of sophistication has not been incorporated in the field of interactive menus in the food services industry. With the use of cutting edge data mining technology, the present invention seeks to provide such a sophisticated configurable custom interactive menu for the food services industry.

### BRIEF SUMMARY OF THE PRESENT INVENTION

The present invention comprises a data-driven customizable interactive menu system for the food services industry. The invention is designed to be deployed in a personal entertainment device (tablet) to replace the use of traditional paper menus. The initial menu configuration is provided by the client and it is typically configured the same way their traditional menus are laid out. Each slot in the menu is assigned a product and an interactive element to it. Traditional and interactive advertisement will also be placed in after each menu page.

The invention captures the entire customer's interaction with the menu such as items selected, time spent viewing menu items, time spent viewing menu advertisement, and time spent viewing menu pages. All of these user interactions will be recorded in a database for later analysis via data mining pattern finding algorithms. Once enough data has been recorded and analyzed the menu can be adapted to present more popular items first, or push less popular items, and an infinite number of different arrangements can be achieved depending on the client's needs. The advertisement pages will be switched based on popularity, weekly, daily, monthly or rotating schedules as defined by the advertiser in conjunction to the client.

All the configuration options will be available to the client and he can change them to fit their individual goals, or they will be provided the option of being presented with optimal configurations based on the data analysis of the data collected.

### BRIEF DESCRIPTION OF THE DRAWINGS

FIG. 1 is a visual illustration of the menu layout.

FIG. 2 is a visual illustration of the menu start page.

FIG. 3 is a visual illustration of a menu items page.

FIG. 4 is a visual illustration of an advertisement page.

FIG. 5 is a visual illustration of the menu end page.

FIG. 6 is a flow diagram describing the menu layout.

FIG. 7 is a diagram of the network required for implementing the present invention.

FIG. 8 is a visual illustration of a menu item overlay.

FIG. 9 is a visual illustration of an advertisement overlay.

FIG. 10 is a stepwise flow diagram describing the general process of the present invention.

FIG. 11 is a stepwise flow diagram describing steps for displaying various elements of the present invention.

FIG. 12 is a stepwise flow diagram describing steps for recording user interactions with menu items.

FIG. 13 is a stepwise flow diagram describing steps for recording user interactions with advertisements.

FIG. 14 is a stepwise flow diagram describing steps for using the historical user interaction data for menu improvement purposes.

FIG. 15 is a stepwise flow diagram describing steps for updating the menu layout.

FIG. 16 is a stepwise flow diagram describing the procedure for updating the menu layout on the portable computing device.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

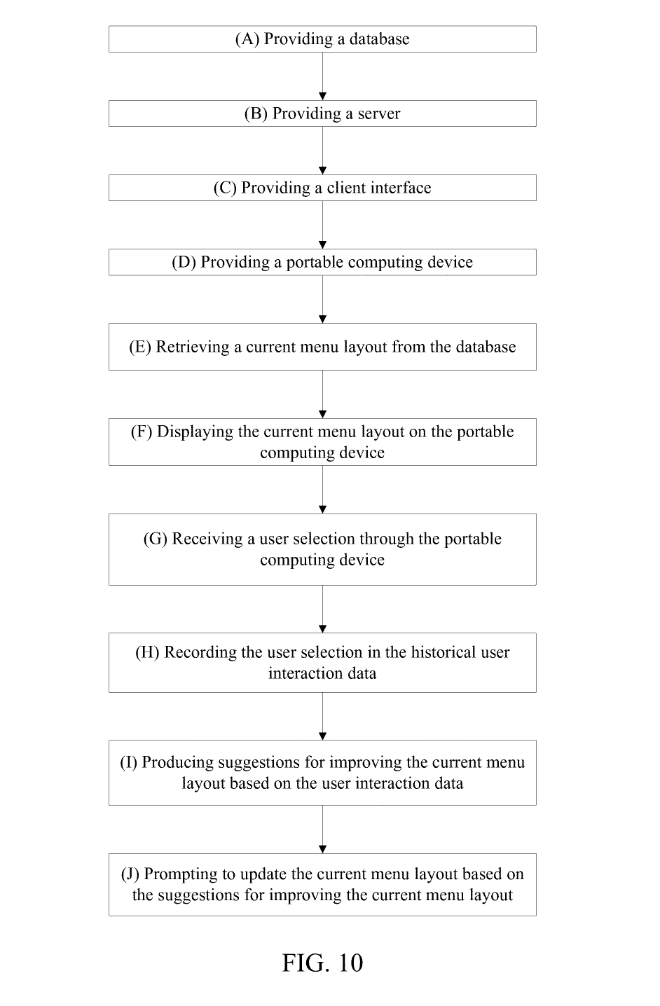

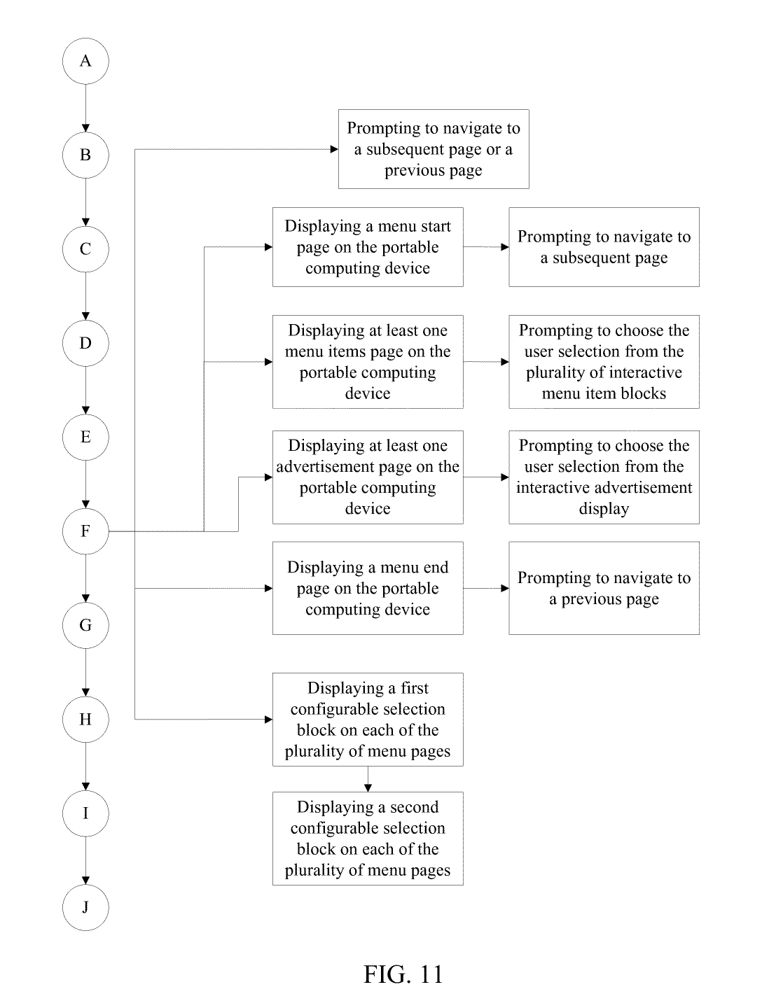

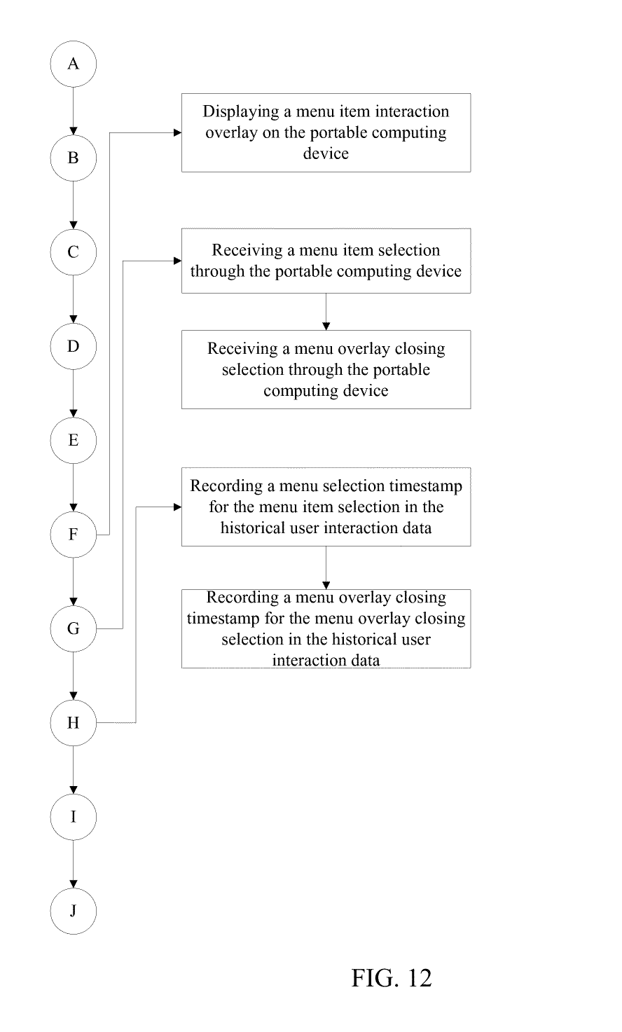

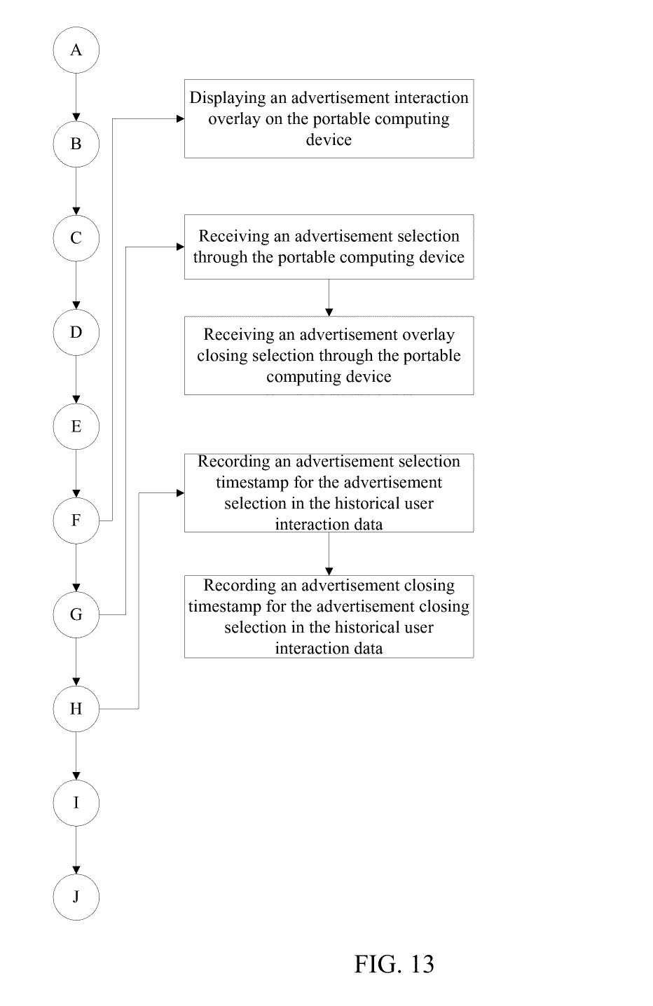

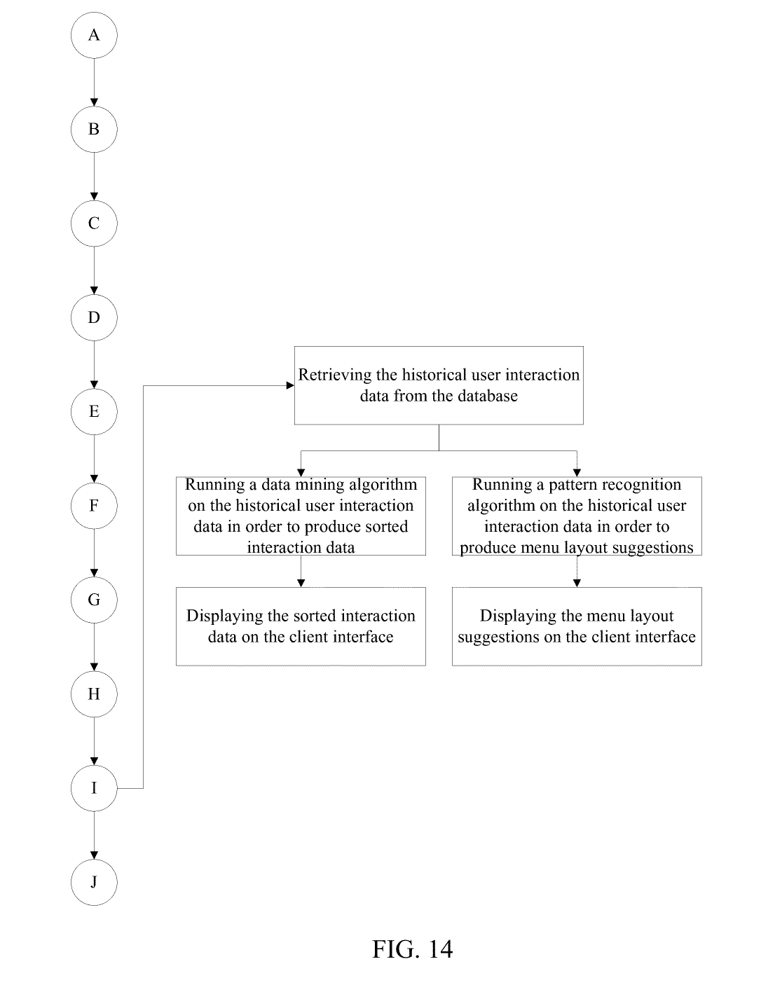

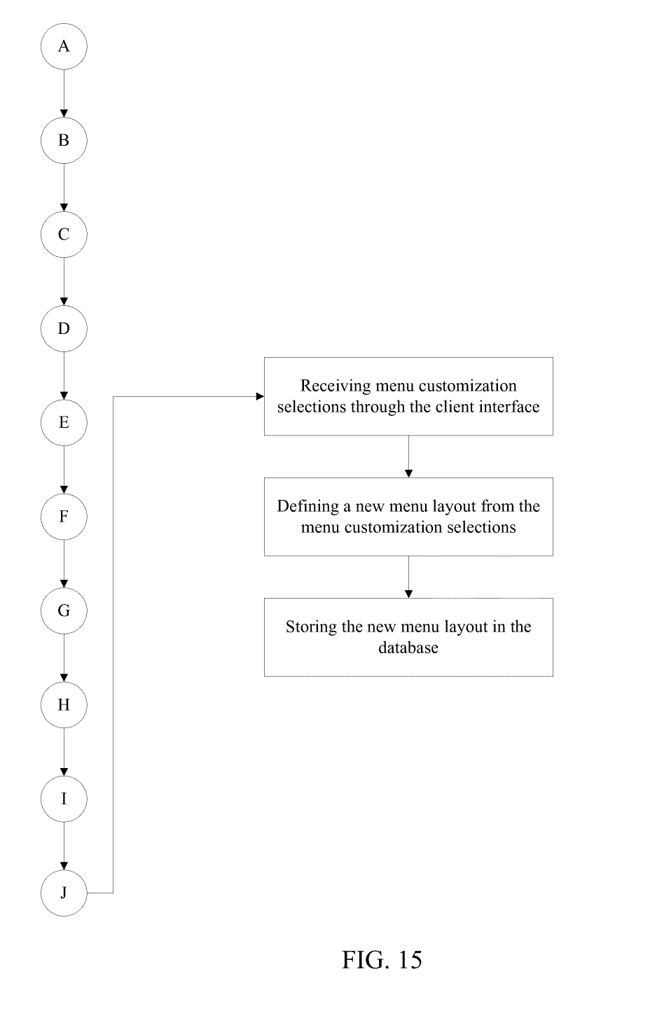

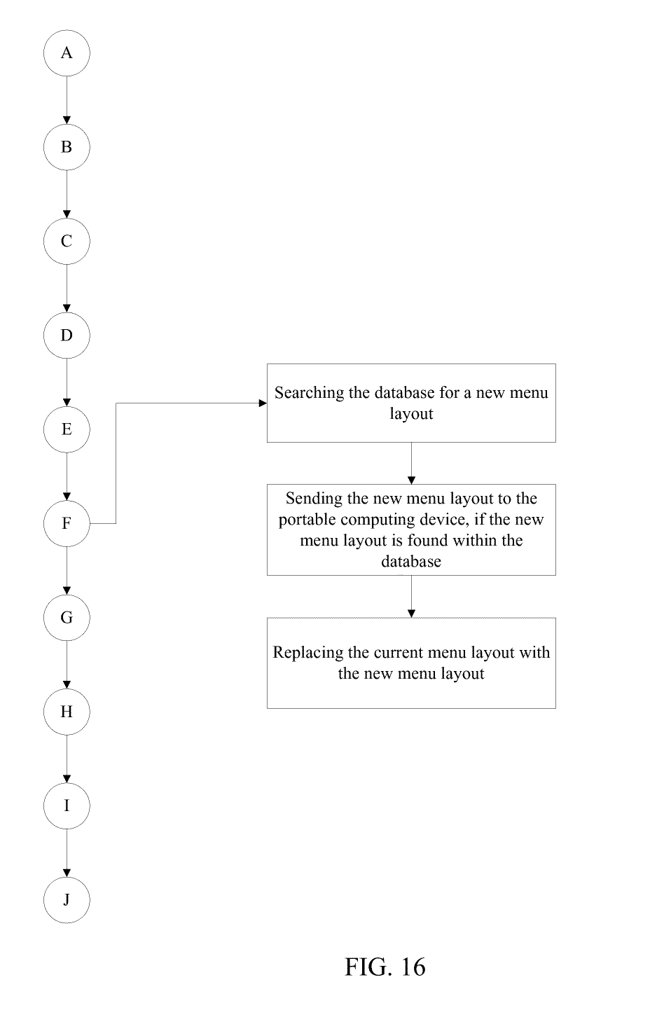

The present invention is a method for implementing a customizable interactive menu system for restaurants with user interaction data analysis capability. The present invention is intended for use in a restaurant, and is implemented on digital computing devices in place of typical paper menus commonly utilized in restaurants. Additionally, the present invention provides capability for customizable advertising to be displayed on the menu, in addition to capability for gathering user interaction data which can be analyzed for patterns or suggestions for improving the menu layout. The process of the present invention is described with stepwise flow diagrams in FIGS. 10-16.

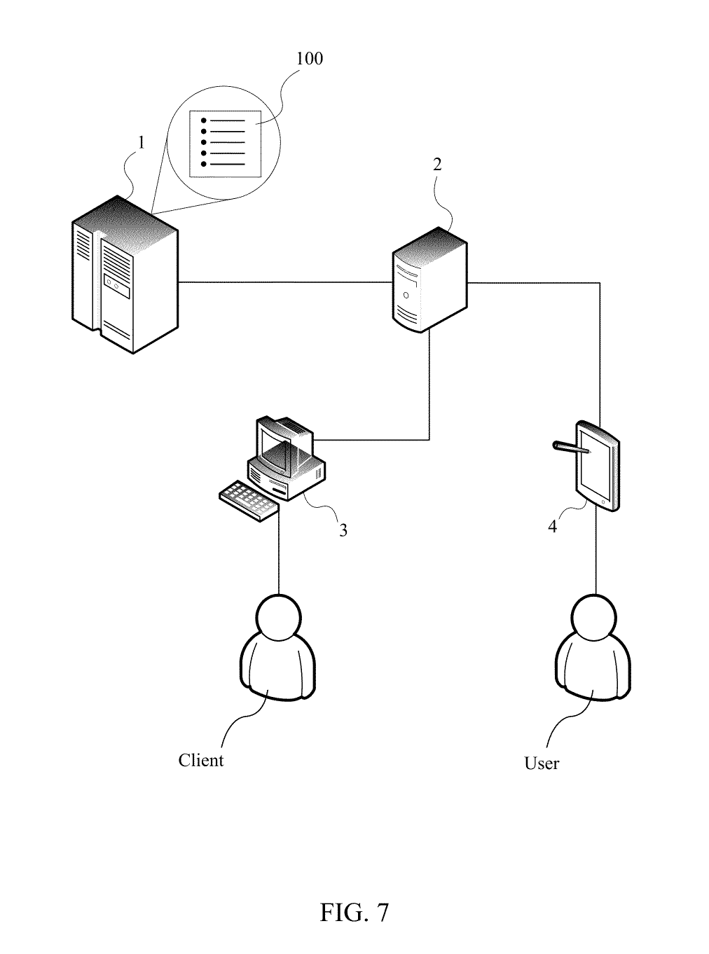

In reference to FIG. 7, a database 1 must be provided, wherein the database 1 comprises historical user interaction data 100 and any other information or software that is useful or needed for implementing the present invention. A server 2 is also provided, and is the primary computing component of the system. The server 2 is networked with the database 1 and is either networked with or otherwise accessible by any other computing devices required to implement the present invention. Networking in this context refers to being connected over a telecommunications data network that allows computing devices to exchange data, such as, but not limited to, a local area network or a wireless network.

One example of such a device which must be provided is a client interface 3. In the preferred embodiment of the present invention, the client interface 3 is accessed by establishing a connection to the server 2 with a web browser on a personal computer. Alternatively, the client interface 3 may be a program installed on the client's personal computer or other computing device which communicates with the server 2 over the network. “Client” herein refers to an owner or other management personnel of a restaurant who is in charge of or is allowed to manage the restaurant's menu by adding, removing, or otherwise reorganizing items on the restaurant's menu.

Another device that must be provided is a portable computing device 4, such as, but not limited to, a tablet computer. The portable computing device 4 physically replaces the typical paper menu and provides the means for implementing the interactive menu of the present invention. A customer, herein after referred to as the user, interacts with the interactive menu and thereby the server 2 through the portable computing device 4 in order to place orders or to interact with advertisements. Ideally, the portable computing device 4 should be a tablet computer with touch screen capability, though it is contemplated that the user may additionally or alternatively interact with the portable computing device 4 through other means such as a mouse, keyboard or voice recognition software.

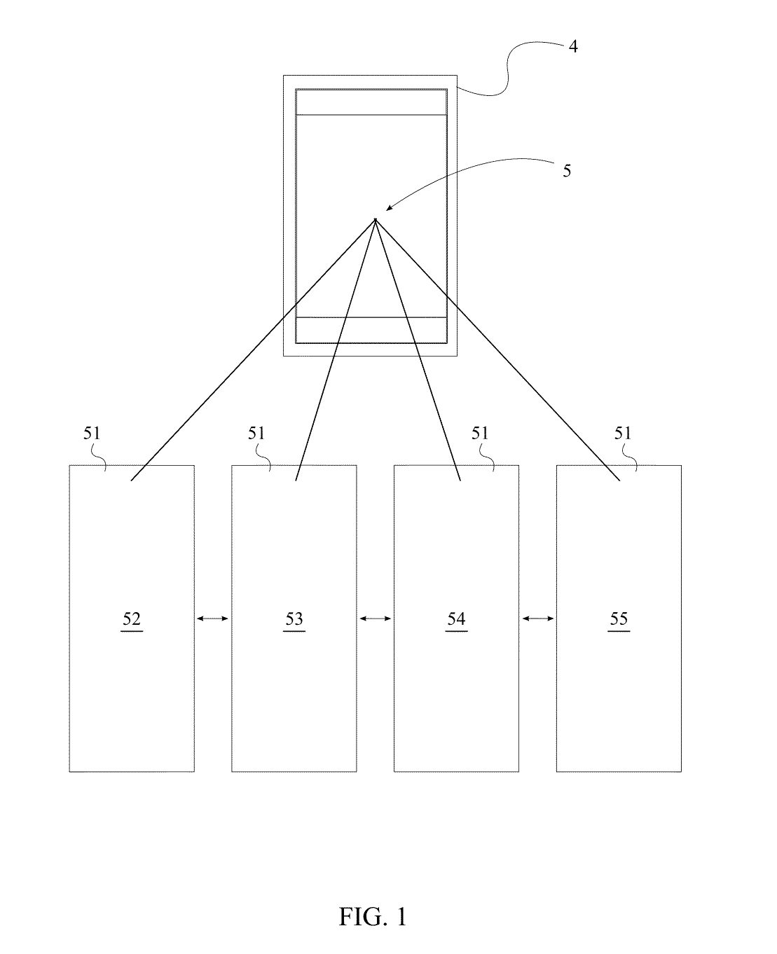

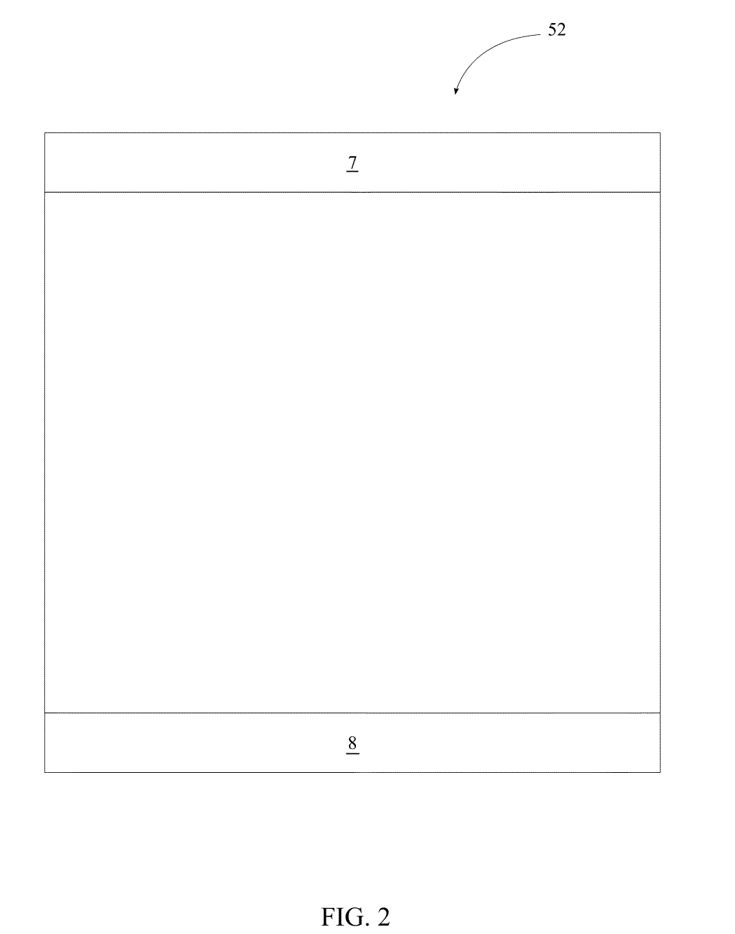

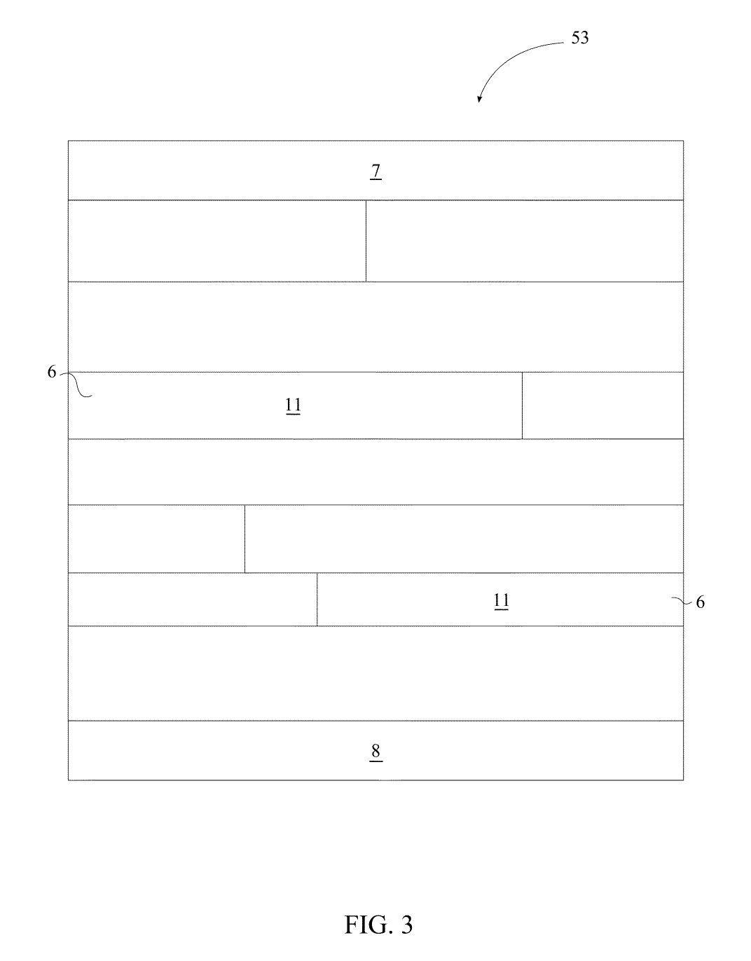

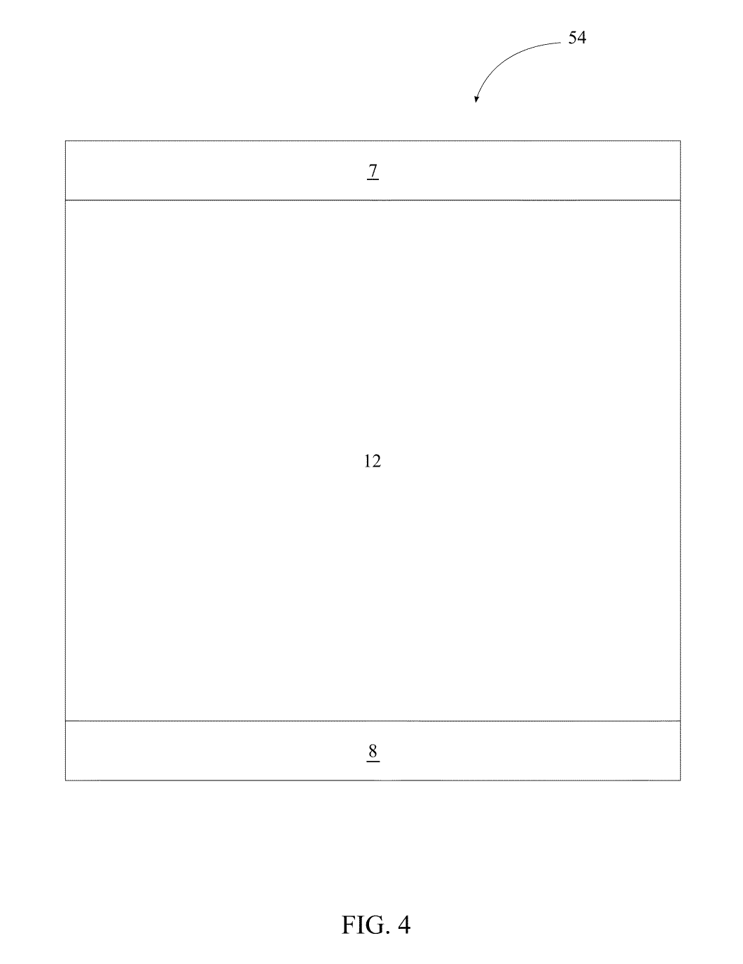

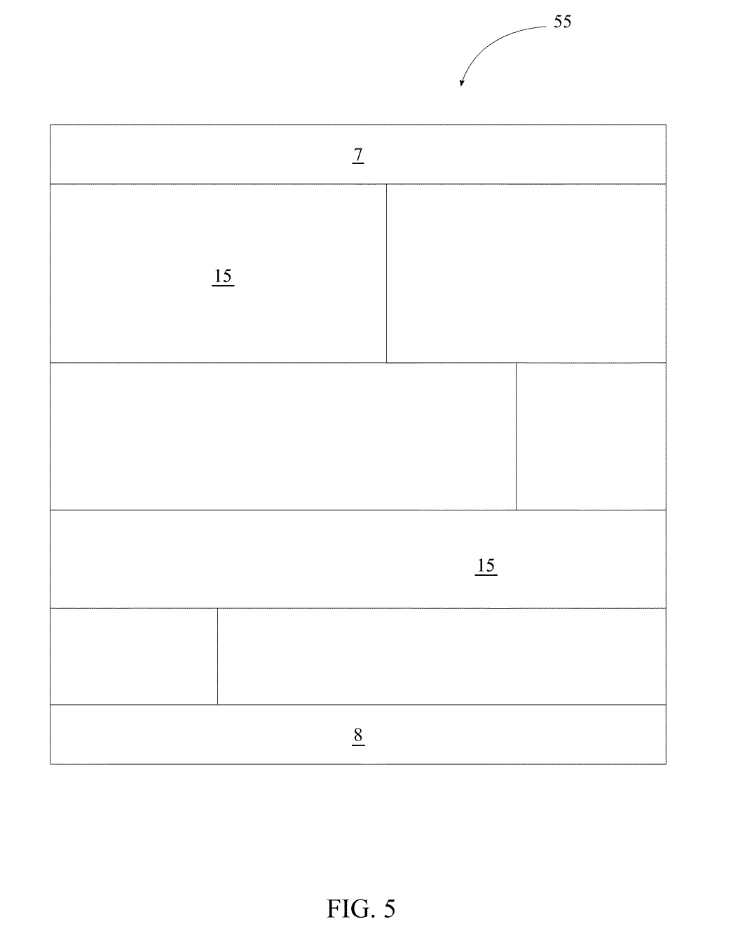

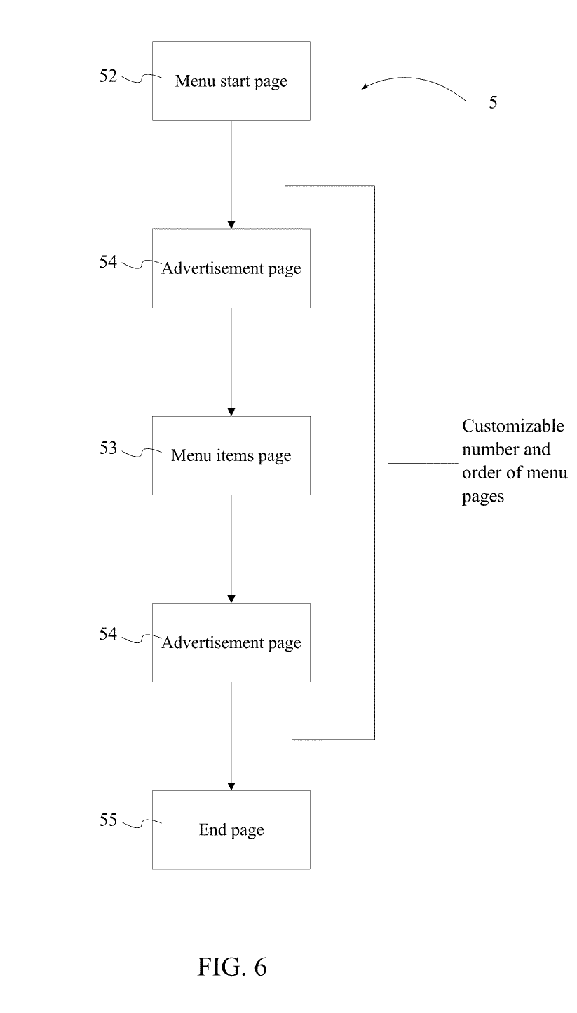

Before the portable computing device 4 can be presented to the customer for perusal, it must be pre-loaded with a current menu layout 5. A general illustration of the current menu layout 5 is shown in FIGS. 1-6. The current menu layout 5 comprises a plurality of menu pages 51, as a typical paper menu layout would. In the preferred embodiment of the present invention, the plurality of menu pages 51, and thereby the menu layout, comprises a menu start page 52, at least one menu start page 53, at least one advertisement page 54, and a menu end page 55. Ultimately however, the order and content of the plurality of menu pages 51 is determined by the client. Initially, the client customizes a menu layout through the client interface 3 that is then designated as the current menu layout 5, which includes the order and number of menu pages as well as any and all configurable sections or blocks of each menu page. Once the current menu layout 5 is defined and stored in the database 1, the current menu layout 5 is retrieved from the database 1 to the portable computing device 4.

The portable computing device 4 is then ready to be used as an interactive menu. To do so, the current menu layout 5 is displayed on the portable computing device 4. Since the current menu layout 5 is interactive, the current menu layout 5 includes user selectable items 6. The user selectable items 6 are blocks or portions of graphical content displayed on the portable computing device 4 which the user can interact with through touch, click or another appropriate interaction method. The user selectable items 6 include menu items, and may additionally include static, dynamic or interactive advertisements.

As the user peruses the current menu layout 5 of the interactive menu, the user has the option to select one of the user selectable items 6. When a user selection is received through the portable computing device 4, the user selection is recorded in the historical user interaction data 100 in the database 1 through communication with the server 2 over the network. The historical user interaction data 100 comprises data for user selections such as, but not limited to, specific selection, date, time of day, season of the year, and current promotions. Over time, as more historical user interaction data 100 is gathered, data reports can be provided to the client indicating common menu interaction patterns, popularity of menu items, and other relevant interaction patterns. Suggestions can be produced by data analysis algorithms for improving the current menu layout 5 based on the historical user interaction data 100, and the client may be prompted to update the current menu layout 5 based on the suggestions for improving the current menu layout 5.

In the preferred embodiment, each of the plurality of menu pages 51 comprises a first configurable selection block 7, which is displayed on each of the plurality of menu pages 51. Additionally, a second configurable selection block 8 may be displayed on each of the plurality of menu pages 51, wherein the second configurable selection block 8 is positioned opposite the first configurable selection block 7. More particularly, the first selection block is positioned at the top of each of the plurality of menu pages 51, and the second selection block is positioned at the bottom of each of the plurality of menu pages 51. The first configurable selection block 7 and the second configurable selection block 8 may alternatively not be present on any or all of the plurality of menu pages 51 at the client's discretion. The first configurable selection block 7 and the second configurable selection block 8 may be used for any purpose. However, in the preferred embodiment, the first configurable selection block 7 comprises controls such as, but not limited to, menu page navigation, while the second configurable selection block 8 is generally utilized for displaying advertisements. Advertisements displayed in the second configurable selection block 8 are preferably retrieved from a list of rotating advertisements in the database 1 in random order or in a specified sequence. If neither the first configurable selection block 7 nor the second configurable selection block 8 is used for menu navigation, other means may be provided in order to prompt the user to navigate to a subsequent menu page or a previous page from the plurality of menu pages 51, such as, but not limited to, a pop-up overlay, a timer, or a virtual button located in a specified location on the current menu layout 5.

In the preferred embodiment of the present invention, the menu start page 52 is displayed first, and the menu end page 55 is displayed last. Between the menu start page 52 and the menu end page 55, any number of menu item pages or advertisement pages may be displayed according to the client's discretion as defined in the current menu layout 5. It is recommended that menu pages and advertisement pages are alternated between the menu start page 52 and the menu end page 55, but any number or order of menu start page 53s and advertisement pages may be comprised in the menu layout.

In the preferred embodiment of the present invention, a menu start page 52 from the plurality of menu pages 51 is initially displayed on the portable computing device 4. The menu start page 52 displays the client's logo and any relevant or desired images or text as typical in the cover of a traditional paper menu. Once the menu start page 52 has been viewed, the user is prompted to navigate to a subsequent page from the plurality of menu pages 51. Alternatively, the menu start page 52 is only displayed for a specified period of time. The subsequent page may be one of the at least one menu start page 53 or one of the at least one advertisement page 54, according to the current menu layout 5 specified by the client.

Subsequently, one of the at least one menu start page 53 is displayed on the portable device. As previously mentioned, each of the at least one menu start page 53 may or may not comprise the first configurable selection block 7 and the second configurable selection block 8, with an emphasis on the second configurable selection block 8 being used to optionally display rotating advertisements. Each of the at least one menu start page 53 comprises a plurality of interactive menu item blocks 11 from the user selectable items 6. The user is prompted to choose one of the user selectable items 6 from the plurality of interactive menu items, either actively through a message, or passively through the user selectable items 6 simply being displayed on the portable computing device 4. The user then makes a menu item selection through the portable computing device 4 by touching or otherwise choosing to interact with one of the plurality of interactive menu item blocks 11 on the portable device. To clarify, the menu item selection corresponds to one of the plurality of interactive menu item blocks 11. Once the menu item selection is received, a menu selection timestamp for the menu item selection is recorded in the historical user interaction data 100.

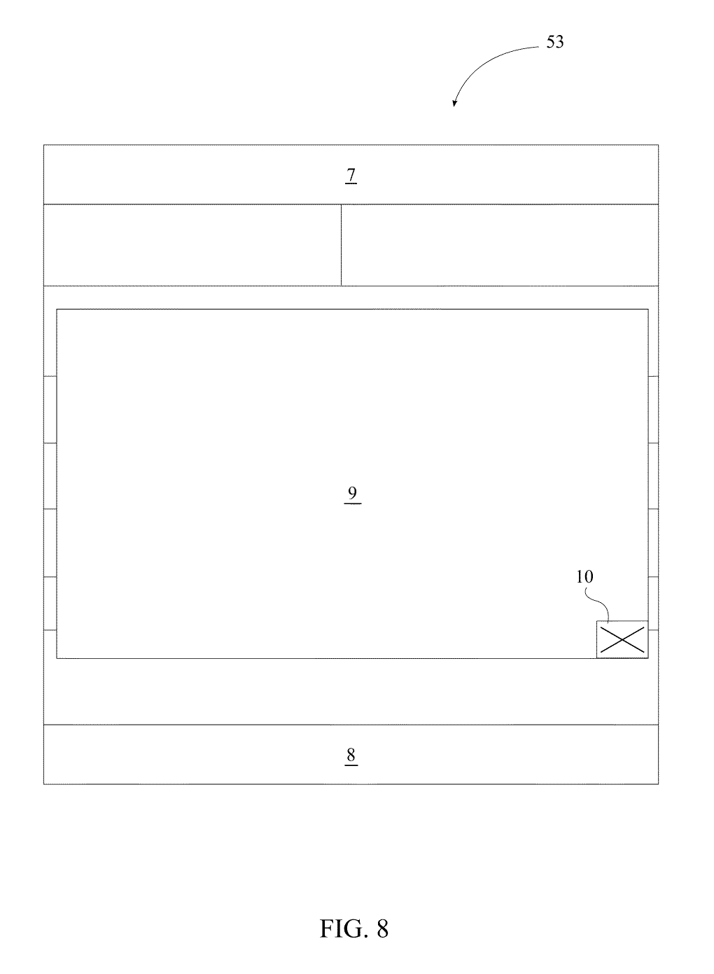

If the menu item selection is received by the portable computing device 4, a menu item interaction overlay 9 is displayed on the portable computing device 4, as illustrated in FIG. 8. The menu item interaction overlay 9 corresponds specifically to the menu item selection, and the menu item interaction overlay 9 comprises a menu overlay closing indicator 10. After the user is finished interacting with the menu item interaction overlay 9, the user interacts with the menu overlay closing indicator 10, and a menu overlay closing selection is received through the portable computing device 4, wherein the menu overlay closing selection corresponds to the menu overlay closing indicator 10. A menu overlay closing timestamp for the menu overlay closing selection is then recorded in the historical user interaction data 100.

Since the client decides the order for displaying the plurality of menu pages 51, one of the at least one advertisement pages 54 may or may not be displayed after each of the at least one menu start page 53. In an alternative embodiment, the client may in fact choose not to display any advertisement pages at all. However, it is recommended for the client to choose to alternate between menu pages and advertisement pages.

In the preferred embodiment, at least one advertisement page 54 from the plurality of menu pages 51 is displayed on the portable computing device 4, wherein each of the at least one advertisement page 54 comprises an interactive advertisement display 12 from the user selectable items 6. Similarly to the at least one menu start page 53, the user is prompted to choose the user selection from the interactive advertisement display 12. Alternatively stated, the user is presented with an advertisement and may choose to interact with the advertisement if the user is interested in the content of the advertisement. Similarly to the interactive menu item blocks 11, if a user touches the interactive advertisement display 12 on the portable computing device 4, an advertisement selection is thereby received by the server 2 through the portable computing device 4, wherein the advertisement selection corresponds to the interactive advertisement display 12. An advertisement selection timestamp for the advertisement selection is then recorded in the historical user interaction data 100.

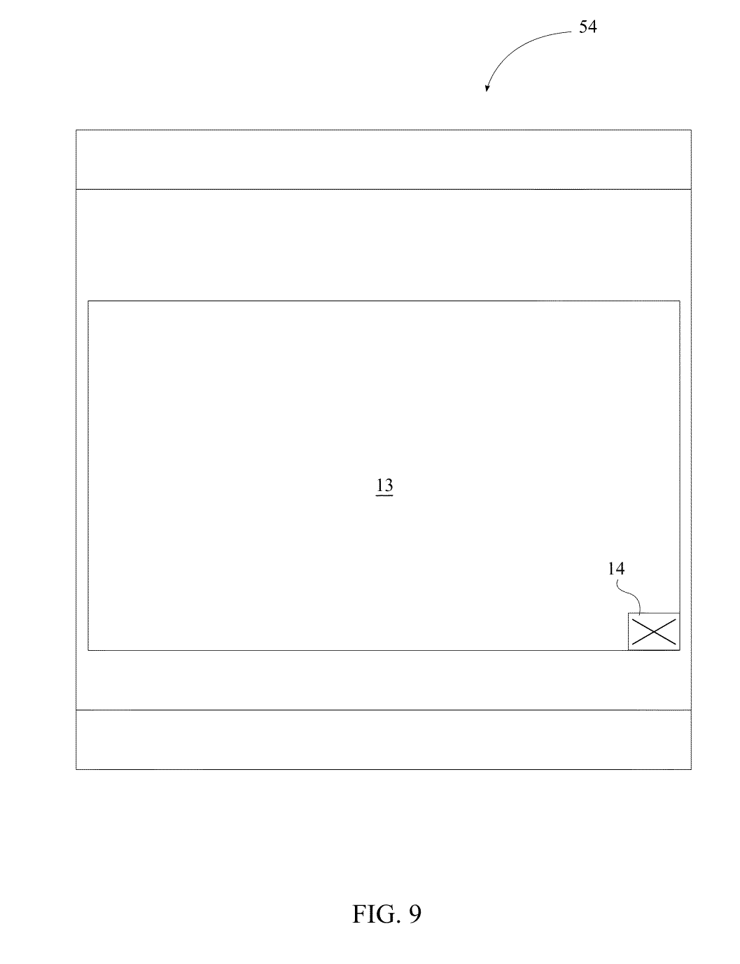

If the advertisement selection is received, an advertisement interaction overlay 13 is subsequently displayed on the portable computing device 4 as illustrated in FIG. 9, wherein the advertisement interaction overlay 13 specifically corresponds to the advertisement selection. The advertisement interaction overlay 13 comprises an advertisement closing indicator 14, and when the user is finished interacting with the advertisement interaction overlay 13, the user interacts with the advertisement closing indicator 14. An advertisement closing selection is then received through the portable computer, wherein the advertisement closing selection corresponds to the advertisement closing indicator 14. The advertisement closing selection causes the advertisement interaction overlay 13 to close and causes an advertisement closing timestamp for the advertisement closing selection to be recorded in the historical interaction data.

After each of the at least one menu start page 53 and each of the at least one advertisement page 54 has been displayed, a menu end page 55 from the plurality of menu pages 51 is displayed on the portable computing device 4. In the preferred embodiment, the menu end page 55 comprises a plurality of configurable sponsor advertisement blocks 15 that are utilized to display various static advertisements for respective menu sponsors. The arrangement of the configurable sponsor advertisement blocks 15 are originally pre-set for the menu layout, but can be changed by the client or based on various appropriate parameters. Additionally, in the preferred embodiment the user is prompted to navigate to a previous page from the plurality of menu pages 51. The user may be prompted with an active message, or simply by displaying a back button that the user can interact with in order to navigate to the previous page. An important feature of the present invention is the gathering of historical user interaction data 100 from the plurality of menu pages 51. In the preferred embodiment, historical user interaction data 100 is not strictly defined only by menu selection timestamps, menu overlay closing timestamps, advertisement selection timestamps, and advertisement closing timestamps, and may include other relevant and useful pieces of data from user interaction with the plurality of menu pages 51, such as, but not limited to, time spent viewing each of the plurality of menu pages 51, data on navigation between menu pages, popular items ordered and popular advertisements interacted with.

In the preferred embodiment, the server 2 is the entity that runs data analysis algorithms on the historical user interaction data 100. Once the historical user interaction data 100 meets or exceeds a defined threshold level for the historical user interaction data 100, the server 2 may run the data analysis algorithms. In one embodiment of the present invention, the data analysis algorithms are run automatically, either at specified time intervals, or at specified data size intervals, wherein the data size intervals describe differing quantities of data in the historical user interaction data 100. In another embodiment, the data analysis algorithms may be triggered manually by the client through the client interface 3.

Data analysis is run on user interactions with the menu item overlays and with the advertisement overlays, specifically the amount of time the user spends looking at the menu item overlays or the advertisement overlays. First, the historical user interaction data 100 is retrieved from the database 1, wherein the user interaction data includes a menu selection timestamp, a menu overlay closing timestamp, an advertisement selection timestamp, and an advertisement closing timestamp. Subsequently, in the preferred embodiment of the present invention, data mining algorithms are run on the historical user interaction data 100 in order to produce sorted interaction data, which is then displayed to the client through the client interface 3. In the preferred embodiment of the present invention, the sorted interaction data includes user interactions with the menu item overlays as well as with the advertisement overlays. Additionally, pattern recognition algorithms are run on the historical user interaction data 100 in order to produce menu layout suggestions, and the menu layout suggestions are then displayed on the client interface 3. Similarly, in the preferred embodiment the menu layout suggestions includes user layout suggestions relating to the plurality of interactive menu items, the interactive advertisement displays 12, as well as the order and number of menu item pages and advertisement pages.

The data mining and pattern recognition algorithms are not herein defined, but should be understood to be currently known methods of data mining and pattern recognition for the purposes of generating sorted data and improvement suggestions.

Once the sorted interaction data and the layout suggestions have been presented to the client through the client interface 3, the client may choose to approve or deny the improvement suggestions, or to manually make custom changes to the current menu layout 5 based on the sorted interaction data and/or improvement suggestions.

To this end, menu customization selections are received by the server 2 through the client interface 3. A new menu layout is defined from the menu customization selections, and the new menu layout is stored in the database 1.

In order to keep the current menu layout 5 on the portable computing device 4 up to date, an update procedure is defined. In one embodiment, the update procedure is initiated by a predefined time schedule. In another embodiment, the update procedure is initiated only when certain conditions are met, such as, but not limited to, the personal computing device being connected to a charger, or when a battery for the personal computing device is at full charge. Additionally, the update procedure may be manually initiated at any time by the client.

In the preferred embodiment of the present invention, the update procedure is as follows. The database 1 is searched for a new menu layout, wherein the new menu layout was modified more recently than the current menu layout 5. If the new menu layout is found within the database 1, the new menu layout is sent to the internal storage of the portable computing device 4, and the current menu layout 5 is replaced with the new menu layout.

Although the invention has been explained in relation to its preferred embodiment, it is to be understood that many other possible modifications and variations can be made without departing from the spirit and scope of the invention as hereinafter claimed.

What is claimed is:

1. A method for implementing a customizable interactive menu system with user interaction data analysis capability by executing computer-executable instructions stored on a non-transitory computer-readable medium comprises the steps of:
providing a database, wherein the database comprises historical user interaction data;
providing a server, wherein the server is networked with the database;
providing a client interface, wherein a client interacts with the server through the client interface;
providing a portable computing device,
wherein a user interacts with the server through the portable computing device;
retrieving a current menu layout from the database, wherein the menu layout comprises a plurality of menu pages;
displaying the current menu layout on the portable computing device, wherein the current menu layout includes user selectable items;
receiving a user selection through the portable computing device, wherein the user selection is one of the user selectable items;
recording the user selection in the historical user interaction data;
producing suggestions for improving the current menu layout based on the historical user interaction data; and
prompting to update the current menu layout based on the suggestions for improving the current menu layout.

2. The method for implementing a customizable interactive menu system with user interaction data analysis capability by executing computer-executable instructions stored on a non-transitory computer-readable medium as claimed in claim 1 comprises the step of:
prompting to navigate to a subsequent menu page or a previous menu page from the plurality of menu pages.

3. The method for implementing a customizable interactive menu system with user interaction data analysis capability by executing computer-executable instructions stored on a non-transitory computer-readable medium as claimed in claim 1 comprises the steps of:
displaying a menu start page from the plurality of menu pages on the portable computing device; and
prompting to navigate to a subsequent page from the plurality of menu pages.

4. The method for implementing a customizable interactive menu system with user interaction data analysis capability by executing computer-executable instructions stored on a non-transitory computer-readable medium as claimed in claim 1 comprises the steps of:
displaying at least one menu items page from the plurality of menu pages on the portable computing device, wherein each of the at least one menu items page comprises a plurality of interactive menu item blocks from the user selectable items; and
prompting to choose the user selection from the plurality of interactive menu item blocks.

5. The method for implementing a customizable interactive menu system with user interaction data analysis capability by executing computer-executable instructions stored on a non-transitory computer-readable medium as claimed in claim 1 comprises the steps of:
displaying at least one advertisement page from the plurality of menu pages on the portable computing device, wherein each of the at least one advertisement page comprises an interactive advertisement display from the user selectable items; and
prompting to choose the user selection from the interactive advertisement display.

6. The method for implementing a customizable interactive menu system with user interaction data analysis capability by executing computer-executable instructions stored on a non-transitory computer-readable medium as claimed in claim 1 comprises the steps of:
displaying a menu end page from the plurality of menu pages on the portable computing device; and
prompting to navigate to a previous page from the plurality of menu pages.

7. The method for implementing a customizable interactive menu system with user interaction data analysis capability by executing computer-executable instructions stored on a non-transitory computer-readable medium as claimed in claim 1 comprises the step of:
displaying a first configurable selection block on each of the plurality of menu pages.

8. The method for implementing a customizable interactive menu system with user interaction data analysis capability by executing computer-executable instructions stored on a non-transitory computer-readable medium as claimed in claim 7 comprises the steps of:
displaying a second configurable selection block opposite the first configurable selection block on each of the plurality of menu pages;

9. The method for implementing a customizable interactive menu system with user interaction data analysis capability by executing computer-executable instructions stored on a non-transitory computer-readable medium as claimed in claim 1 comprises the steps of:
receiving a menu item selection through the portable computing device,
wherein the menu item selection corresponds to one of a plurality of interactive menu item blocks;
wherein the user makes the menu item selection by touching one of the plurality of interactive menu item blocks on the portable computing device; and
recording a menu selection timestamp for the menu item selection in the historical user interaction data.

10. The method for implementing a customizable interactive menu system with user interaction data analysis capability by executing computer-executable instructions stored on a non-transitory computer-readable medium as claimed in claim 9 comprises the steps of:
displaying a menu item interaction overlay on the portable computing device, if the menu item selection is received by the portable computing device;
wherein the menu item interaction overlay corresponds to the menu item selection;
wherein the menu item interaction overlay comprises a menu overlay closing indicator;
receiving a menu overlay closing selection through the portable computing device, wherein the menu overlay closing selection corresponds to the menu closing indicator; and
recording a menu overlay closing timestamp for the menu overlay closing selection in the historical user interaction data.

11. The method for implementing a customizable interactive menu system with user interaction data analysis capability by executing computer-executable instructions stored on a non-transitory computer-readable medium as claimed in claim 1 comprises the steps of:
receiving an advertisement selection through the portable computing device,
wherein the advertisement selection corresponds to an interactive advertisement display;
wherein the user makes the advertisement selection by touching the interactive advertisement display on the portable computing device; and
recording an advertisement selection timestamp for the advertisement selection in the historical user interaction data.

12. The method for implementing a customizable interactive menu system with user interaction data analysis capability by executing computer-executable instructions stored on a non-transitory computer-readable medium as claimed in claim 11 comprises the steps of:
displaying an advertisement interaction overlay on the portable computing device,
if the advertisement selection is received;
wherein the advertisement interaction overlay corresponds to the advertisement selection;
wherein the advertisement interaction overlay comprises an advertisement closing indicator;
receiving an advertisement closing selection through the portable computing device,
wherein the advertisement closing selection corresponds to the advertisement closing indicator; and
recording an advertisement closing timestamp for the advertisement closing selection in the historical user interaction data.

13. The method for implementing a customizable interactive menu system with user interaction data analysis capability by executing computer-executable instructions stored on a non-transitory computer-readable medium as claimed in claim 1 comprises the step of:
retrieving the historical user interaction data from the database, wherein the user interaction data includes a menu selection timestamp, a menu overlay closing timestamp, an advertisement selection timestamp, and an advertisement closing timestamp.

14. The method for implementing a customizable interactive menu system with user interaction data analysis capability by executing computer-executable instructions stored on a non-transitory computer-readable medium as claimed in claim 13 comprises the steps of:
running a data mining algorithm on the historical user interaction data in order to produce sorted interaction data; and
displaying the sorted interaction data on the client interface.

15. The method for implementing a customizable interactive menu system with user interaction data analysis capability by executing computer-executable instructions stored on a non-transitory computer-readable medium as claimed in claim 13 comprises the steps of:
running a pattern recognition algorithm on the historical user interaction data in order to produce menu layout suggestions; and
displaying the menu layout suggestions on the client interface.

16. The method for implementing a customizable interactive menu system with user interaction data analysis capability by executing computer-executable instructions stored on a non-transitory computer-readable medium as claimed in claim 1 comprises the steps of:
receiving menu customization selections through the client interface;
defining a new menu layout from the menu customization selections; and
storing the new menu layout in the database.

17. The method for implementing a customizable interactive menu system with user interaction data analysis capability by executing computer-executable instructions stored on a non-transitory computer-readable medium as claimed in claim 1 comprises the steps of:
searching the database for a new menu layout, wherein the new menu layout was modified more recently than the current menu layout;
sending the new menu layout to the portable computing device, if the new menu layout is found within the database; and
replacing the current menu layout with the new menu layout.
